(19) United States
(12) Patent Application Publication
(10) Pub. No.: US 2003/0151250 A1
(43) Pub. Date: Aug. 14, 2003

(54) Mounting structure for tubular member

(76) Inventors: Kenji Miura, Toyoake-City (JP); Hiroyuki Yoshida, Kariya-City (JP)

Correspondence Address: HARNESS, DICKEY & PIERCE, P.L.C., P.O. BOX 828, BLOOMFIELD HILLS, MI, 48303, US

(21) Appl. No.: 10/358,703

(22) Filed: Feb. 5, 2003

(30) Foreign Application Priority Data
Feb. 12, 2002 (JP) 2002-034081

(51) Int. Cl. B60D 1/62

(52) U.S. Cl. 285/62

(57) ABSTRACT

A mounting structure for a tubular member is disclosed. At least a claw (11) making up a protrusion is formed on the outer surface of a drain hose (1) making up a tubular member. At least an annular depressed portion (22) is formed on the inner surface of a holding hole (21) of a grommet (2) making up a holding member. The claw (11) and the depressed portion (22) are fitted with each other, so that the drain hose (1) is securely held in a manner such that it cannot come off from the grommet (2) supported by a body panel (3). The outer surface of the drain hose (1) is formed with a mark (12) providing an indication of the amount of insertion.

### BACKGROUND OF THE INVENTION

1. Field of the Invention

The present invention relates to a mounting structure for a tubular member or, in particular, to a mounting structure for a drain hose for discharging the condensed water flowing out of an evaporator of an air conditioning system of an automobile.

2. Description of the Related Art

In the refrigerant evaporator used for the refrigeration cycle of the automotive air conditioning system, the air is cooled by heat exchange between the refrigerant passing through the inside of the refrigerant evaporator and the air passing through the outside of the refrigerant evaporator. In the process, the water in the air is condensed into condensed water which is attached to and flows down the surface of the refrigerant evaporator.

A drain pan for receiving the condensed water is arranged under the refrigerant evaporator and connected to a drain hose for discharging the condensed water out of the passage compartment. The refrigerant evaporator is arranged inside the passenger compartment, and the condensed water generated in the refrigerant evaporator is discharged out of the cabin by leading it to the engine compartment through the drain hose.

In taking out the drain hose to the engine compartment from within passenger compartment, a grommet is conventionally used to pass the drain hose by way of an insertion hole formed through a wall (body panel) separating the interior of the passenger compartment and the engine compartment from each other.

In this case, an assembly formed of the drain hose and the grommet integrally with each other is passed through the insertion hole and pulled from the engine compartment side, so that the grommet is fitted securely in the insertion hole of the body panel.

With the (three-dimensional) complication of the shape of the drain hose, however, the drain hose and the grommet cannot be integrally formed depending on the shape involved. In such a case, the drain hose and the grommet must be fabricated and mounted separately from each other.

In a mounting structure for the drain hose fabricated separately from the grommet, the drain hose is pulled out to the engine compartment from within the passenger compartment through an insertion hole, after which the grommet is mounted in the insertion hole from the engine compartment side, and the drain hose is mounted in a predetermined position in the insertion hole of the body panel. This unavoidable process is very low in workability. Also, the positioning work is not easy as the position of the drain hose cannot be uniquely determined.

As an attempt to overcome this problem, a conventional mounting structure for a drain hose is disclosed in Japanese Unexamined Patent Publication No. 5-319079. In this mounting structure, a drain hose is formed with a large-diameter portion, a small-diameter portion and a connecting portion for connecting the large- and small-diameter portions, and a grommet formed with two protrusions on the whole inner periphery thereof is fitted in contact with the outer periphery of the drain hose over the large- and small-diameter portions thereof.

Even with this conventional mounting structure, however, in spite of the two protrusions being formed over the whole inner peripheral surface of the grommet, the drain hose is simply inserted in the grommet. After being mounted, therefore, the drain hose comes off from the grommet easily, thereby leading to the problem that the drain hose is separated from the grommet by shock or the like. Also, the shape of the drain hose is so complicated that the fabrication thereof is difficult and expensive as compared with a tube having a single diameter.

### SUMMARY OF THE INVENTION

The present invention has been developed in view of the problems mentioned above, and the object thereof is to provide a mounting structure for a tubular member which can prevent the drain hose from coming off from the grommet.

According to one aspect of the invention, there is provided a mounting structure, for a tubular member, wherein at least a protruded portion (or a depressed portion) is formed over the whole or a part of the circumference of the outer surface of the tubular member and at least a corresponding depressed portion (or a protruded portion) is formed over the whole or a part of the circumference of the inner surface of the holding hole of a holding member so that the protruded portion (or the depressed portion) of the tubular member and the depressed portion (or the protruded portion) of the holding member are fitted with each other. In this way, the tubular member is held securely by being prevented from inconveniently coming off from the holding member.

According to another aspect of the invention, there is provided a mounting structure, for a tubular member, wherein the protruded portion or the depressed portion formed on the tubular member has a triangular cross section, whereby the tubular member can be inserted in the holding member easily but in a manner not to be easily separated from the holding member.

According to still another aspect of the invention, there is provided a mounting structure for a tubular member, wherein a mark for checking the amount of insertion of the tubular member into the holding member is attached on the outer peripheral surface of the tubular member, whereby a short or an over insertion of the tubular member into the holding member can be prevented, thereby making it possible to hold the tubular member in position.

The present invention may be more fully understood from the description of preferred embodiments of the invention, as set forth below, together with the accompanying drawings.

### BRIEF DESCRIPTION OF THE DRAWINGS

FIG. 1 includes a sectional view and a plan view of a mounting structure for a tubular member according to an embodiment of the invention.

FIG. 2 includes a sectional view and a plan view of a mounting structure for a tubular member according to another embodiment of the invention.

FIG. 3 is a perspective view of a refrigeration system comprising a drain hose and a grommet according to the invention.

### DESCRIPTION OF THE PREFERRED EMBODIMENTS

A mounting structure for a tubular member according to an embodiment of the invention will be explained below with reference to the drawings. The description that follows deals with an example of application of the mounting structure for a tubular member according to the invention to an air conditioning system of a vehicle (specifically, an automotive air conditioning system). Nevertheless, this mounting structure is of course applicable to tubular members in general and with equal effect.

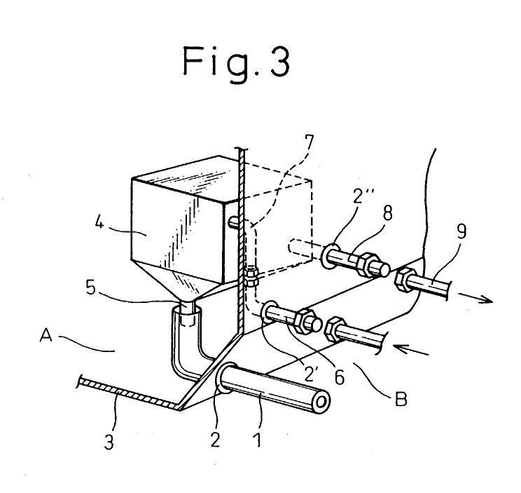

In an automotive air conditioning system, as shown in FIG. 3, a cooling unit 4 with a refrigerant evaporator (not shown) built therein for the refrigeration cycle is arranged in a passenger compartment A and mounted on a body panel 3 making up an object member defining the passenger compartment A and an engine compartment B. A drain pipe 5 for discharging the condensed water (drain water) from the refrigerant evaporator is arranged on the bottom of the cooling unit 4. The drain pipe 5 is coupled with a drain hose 1 constituting a tubular member, and extended to the engine compartment B side through a grommet 2 making up a holding member and the body panel 3. The drain water is discharged out of the cabin by way of the engine compartment B.

The cooling unit 4 has arranged therein a high-pressure pipe 6 into which the liquid refrigerant flows from a liquid tank (not shown) for forming the refrigeration cycle. This high-pressure pipe 6 is projected into the passenger compartment A through a grommet 2′ and screwed to an inlet pipe 7 of the refrigerant evaporator.

The low-pressure pipe 8 of the cooling unit 4 is projected to the engine compartment B through a grommet 2′ and the body panel 3, and screwed to an intake pipe 9 of the compressor (not shown).

The mounting structure for a tubular member according to this invention is suitable especially for an application in which the drain hose (tubular member) 1 is mounted on the body panel (object member) 3 through the grommet (holding member) 2.

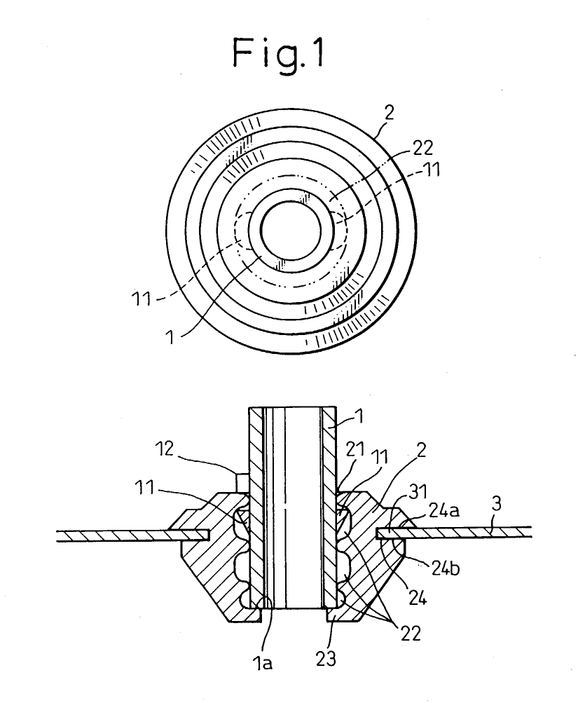

FIG. 1 includes a plan view and a sectional view showing the essential parts of the mounting structure for a tubular member according to an embodiment of the invention. The drain hose 1 making up a tubular member is formed of a soft material such as rubber, and has a plurality (two in FIG. 1) of claws 11 constituting protruded portions arranged on a part of the outer peripheral circumferential surface thereof. The claws 11 may alternatively be formed over the whole of the outer circumference. The cross section of each claw 11 preferably is a triangle, or more preferably a right triangle of which the short side is located above the other two sides at right angles to the outer peripheral surface of the drain hose 1, as shown in FIG. 1.

The outer peripheral surface of the drain hose 1 above the claws 11 is formed with a mark 12 used as a measure giving an indication of the amount by which the drain hose 1 is inserted into the grommet 2. This mark 12 may be either a rib or the like protrusion or a simple scale division.

The grommet 2 making up a holding member is formed of a soft material, such as rubber, adapted to seal water, oil, etc. The grommet 2 is formed with a holding hole 21 therethrough for receiving the drain hose 1. A plurality of annular depressed portions 22 are formed on the inner surface of the holding hole 21 of the grommet 2. One instead of three annular depressed portions 22 may be formed unlike those in FIG. 1. The annular depressed portions 22 of the grommet 2 each have a depth and a width large enough to receive the claws 11 of the drain hose 1.

An annular protrusion 23 in contact with the end surface 1a of the drain hose 1 is formed at the lower part of the holding hole 21 of the grommet 2. The insertion of the drain hose 1 into the grommet 2 is stopped as the end surface 1a comes into contact with the protrusion 23.

Further, the outer peripheral surface of the grommet 2 is formed with an annular groove 24. The upper wall 24a of the groove 24 extends radially more than the lower wall 24b. The peripheral edge 31 of the insertion hole of the body panel 3 is fitted in the groove 24 on the outer peripheral surface of the grommet 2 so that the drain hose 1 inserted in the grommet 2 is securely fixed on the body panel 3.

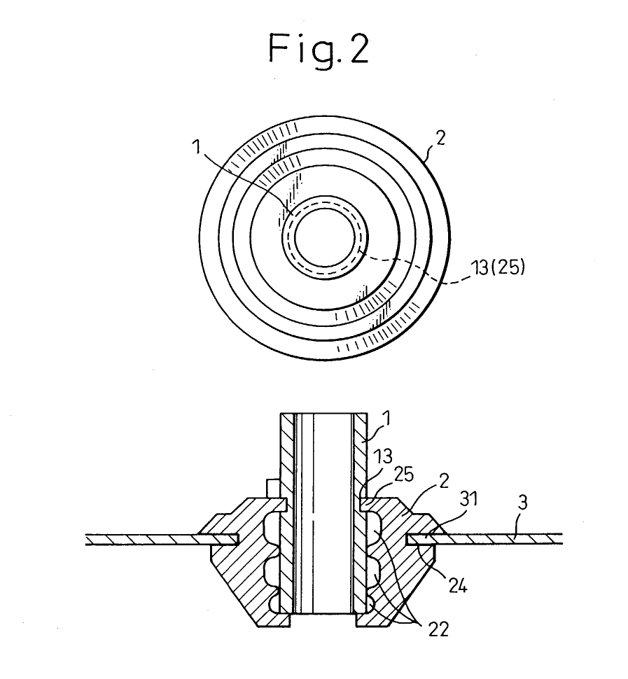

FIG. 2 shows a mounting structure for a tubular member according to another embodiment of the invention. In this embodiment, as shown in FIG. 2, an annular depressed portion 13 is formed on the outer peripheral surface of the drain hose 1, while an annular protruded portion 25 is formed at the upper part of the inner surface of the holding hole 21 of the grommet 2. The annular depressed portion 13 of the drain hose 1 and the annular protruded portion 25 of the grommet 2 are fitted with each other, thereby securely fixing the drain hose 1 to the grommet 2. The configuration of the other parts is similar to that of the embodiment described above.

It will thus be understood from the foregoing description that, according to this invention, the drain hose and the grommet are securely fixed with each other by the depressed and depressed portions thereof fitted with each other. Therefore, this invention obviates the problem of the drain hose coming off from the grommet due to shock or the like.

While the invention has been described by reference to specific embodiments chosen for purposes of illustration, it should be apparent that numerous modifications could be made thereto by those skilled in the art without departing from the basic concept and scope of the invention.

1. A mounting structure for a tubular member, comprising:
a cylindrical tubular member; and
a holding member including a groove adapted to be fitted with a peripheral edge of an insertion hole formed in an object member and a holding hole for insertion of said tubular member;
wherein said tubular member is fixed on said object member through said holding member; and
wherein at least a protrusion (or a depression) formed over the whole or a part of the outer peripheral circumferential surface of said tubular member and at least a corresponding depression (or a corresponding protrusion) formed over the whole or a part of the inner peripheral circumferential surface of said holding hole of said holding member are fitted with each other.

2. A mounting structure for a tubular member according to claim 1, wherein said protrusion or depression, as the case may be, formed on said tubular member has a triangular cross section in order to facilitate insertion of said tubular member into said holding hole of said holding member, on the one hand, and to make it difficult for said tubular member to come off from said holding member, on the other hand.

3. A mounting structure for a tubular member according to claim 1, wherein a mark is attached on the outer peripheral surface of said tubular member in order to indicate the amount of insertion of said tubular member into said holding hole of said holding member.

4. A mounting structure for a tubular member according to claim 2, wherein a mark is attached on the outer peripheral surface of said tubular member in order to indicate the amount of insertion of said tubular member into said holding hole of said holding member.

5. A mounting structure for a tubular member according to claim 1, wherein an annular protrusion is formed at the lower part of said holding hole of said holding member in such a position as to come into contact with the end surface of said tubular member at the time of insertion of said tubular member.
